(19) United States
(12) Patent Application Publication
(10) Pub. No.: US 2020/0231062 A1
(43) Pub. Date: Jul. 23, 2020

(54) ELECTRICALLY DRIVEN VEHICLE MANAGEMENT DEVICE, ELECTRICALLY DRIVEN VEHICLE MANAGEMENT SYSTEM, AND ELECTRICALLY DRIVEN VEHICLE MANAGEMENT METHOD

(71) Applicant: HONDA MOTOR CO., LTD., Tokyo (JP)

(72) Inventors: Atsuyuki Suzuki, Wako-shi (JP); Hirokazu Watanabe, Wako-shi (JP); Yasuaki Aoki, Wako-shi (JP); Masanori Takeda, Wako-shi (JP)

(21) Appl. No.: 16/703,300

(22) Filed: Dec. 4, 2019

(30) Foreign Application Priority Data
Jan. 23, 2019 (JP) 2019-009435

(51) Int. Cl. B60L 53/65; B60L 53/66; B60R 25/00; B60R 25/33; H02J 7/00

(52) U.S. Cl. CPC B60L 53/65; B60L 53/66; H02J 7/00045; B60R 25/33; B60R 25/003

(57) ABSTRACT

An electrically driven vehicle management device is configured to acquire vehicle inherent information that can be used in identifying an electrically driven vehicle when a charging cable attachable to and detachable from the electrically driven vehicle is connected to the electrically driven vehicle, and determine, based on the acquired vehicle inherent information, a coping operation to be performed in relation to the electrically driven vehicle to which the charging cable is connected.

### INCORPORATION BY REFERENCE

The present application claims priority under 35 U.S.C. § 119 to Japanese Patent Application No. 2019-009435 filed on Jan. 23, 2019. The content of the applications is incorporated herein by reference in its entirety.

### BACKGROUND OF THE INVENTION

### Field of the Invention

The present invention relates to an electrically driven vehicle management device, an electrically driven vehicle management system, and an electrically driven vehicle management method capable of finding out a specific electrically driven vehicle that has no remote communication function and enabling a coping operation relevant to the electrically driven vehicle.

### Description of the Related Art

An electrically driven vehicle is generally equipped with a so-called telematics control unit (TCU) that performs remote communications, and can communicate with a server or the like via a network such as Internet. Thus, for example, when the electrically driven vehicle is stolen, an external server or the like can communicate with the TCU of the electrically driven vehicle and access a global positioning system (GPS) device provided in the electrically driven vehicle to identify the location of the electrically driven vehicle or track the movement of the electrically driven vehicle.

However, the TCU may not be mounted on an electrically driven vehicle to be shipped depending on the destination of an electrically driven vehicle. In this case, it is impossible for the server or the like to identify the location of the electrically driven vehicle or track the movement of the electrically driven vehicle as described above. Therefore, even in an electrically driven vehicle not equipped with the TCU or the like and having no remote communication function, it will be convenient if the operation of the electrically driven vehicle can be controlled, for example, by finding out the specific electrically driven vehicle from the server or the like and causing the vehicle to transmit positional information.

A conventionally known anti-theft device suppresses unauthorized movement of an electrically driven vehicle using a charging cable that connects a charging facility for the electrically driven vehicle to the electrically driven vehicle (see Japanese Patent Laid-Open No. 2012-211465). This anti-theft device is mounted on the electrically driven vehicle and performs theft prevention processing, such as output of alarm sound, traveling restriction of the electrically driven vehicle, or reporting, upon detection of an unexecuted predetermined manipulation when disengaging a connector of the charging cable or detection of cutting of the charging cable.

However, the above-described conventional device is intended to prevent the electrically driven vehicle from being stolen, and the location of the electrically driven vehicle, if it is once stolen, is no longer tracked.

In view of the above background, the present invention intends to realize an electrically driven vehicle management device that can find out a specific electrically driven vehicle, even if it is an electrically driven vehicle having no remote communication function, and can perform a predetermined coping operation relevant to the electrically driven vehicle, such as causing the electrically driven vehicle to perform a predetermined operation.

### SUMMARY OF THE INVENTION

One aspect of the present invention provides an electrically driven vehicle management device including an inherent information acquisition unit configured to acquire vehicle inherent information that can be used in identifying the electrically driven vehicle when a charging cable attachable to and detachable from the electrically driven vehicle is connected to the electrically driven vehicle, and an operation determination unit configured to determine, based on the acquired vehicle inherent information, a coping operation to be performed in relation to the electrically driven vehicle to which the charging cable is connected.

In another aspect of the present invention, the operation determination unit determines whether the electrically driven vehicle having the vehicle inherent information is a tracking target vehicle based on the vehicle inherent information, and determines the coping operation to be performed in relation to the electrically driven vehicle when the electrically driven vehicle is the tracking target vehicle.

In another aspect of the present invention, the tracking target vehicle includes a non-conforming vehicle that does not conform with a predetermined rule or does not comply with a predetermined rule, and the operation determination unit determines the coping operation to be performed in relation to the electrically driven vehicle according to the type of nonconformity.

In another aspect of the present invention, the type of nonconformity includes stolen vehicle, tax delinquent vehicle, or non-inspected vehicle.

In another aspect of the present invention, the coping operation to be performed in relation to the electrically driven vehicle includes reporting to a predetermined reporting destination, and/or inhibiting travel of the electrically driven vehicle.

In another aspect of the present invention, the charging cable configures a power feeding path to the electrically driven vehicle and configures a communication path with the electrically driven vehicle, and the inherent information acquisition unit acquires the vehicle inherent information received from the electrically driven vehicle via the charging cable.

In another aspect of the present invention, the inherent information acquisition unit acquires, as the vehicle inherent information of the electrically driven vehicle, an image capturing the electrically driven vehicle to which the charging cable is connected.

Another aspect of the present invention provides an electrically driven vehicle management system, which includes any one of the above-described electrically driven vehicle management devices, and at least one charging apparatus communicably connected to the electrically driven vehicle management device, wherein the charging apparatus includes a vehicle information acquisition unit configured to acquire vehicle inherent information of the electrically driven vehicle in response to reception of an instruction from the electrically driven vehicle management device, and a command processing unit configured to transmit a command to the electrically driven vehicle in response to reception of an instruction from the electrically driven vehicle management device.

Another aspect of the present invention provides an electrically driven vehicle management method performed by an electrically driven vehicle management device that finds out an electrically driven vehicle and determines a coping operation, the method including causing an inherent information acquisition unit to acquire vehicle inherent information that can be used in identifying the electrically driven vehicle to which a charging cable is connected, when the charging cable attachable to and detachable from the electrically driven vehicle is connected to the electrically driven vehicle, and causing an operation determination unit to determine, based on the acquired vehicle inherent information in the acquiring, a coping operation to be performed in relation to the electrically driven vehicle to which the charging cable is connected.

According to the aspect of the present invention, it is possible to find out an electrically driven vehicle having no remote communication function and to perform a predetermined coping operation relevant to the electrically driven vehicle, such as causing the electrically driven vehicle to perform a predetermined operation, or reporting to a predetermined reporting destination.

### BRIEF DESCRIPTION OF THE DRAWINGS

FIG. 1 is a diagram illustrating an exemplary scene in which an electrically driven vehicle management device according to an embodiment of the present invention is used;

FIG. 2 is a diagram illustrating an exemplary configuration of the electrically driven vehicle management device according to the present invention;

FIG. 3 is a diagram illustrating an exemplary configuration of a charging apparatus that can be used together with the electrically driven vehicle management device according to the present invention;

FIG. 4 is a diagram illustrating an exemplary configuration of an electrically driven vehicle managed by the electrically driven vehicle management device according to the present invention; and

FIG. 5 is a flow chart illustrating an operation procedure of the electrically driven vehicle management device according to the present invention.

### DETAILED DESCRIPTION OF THE PREFERRED EMBODIMENT

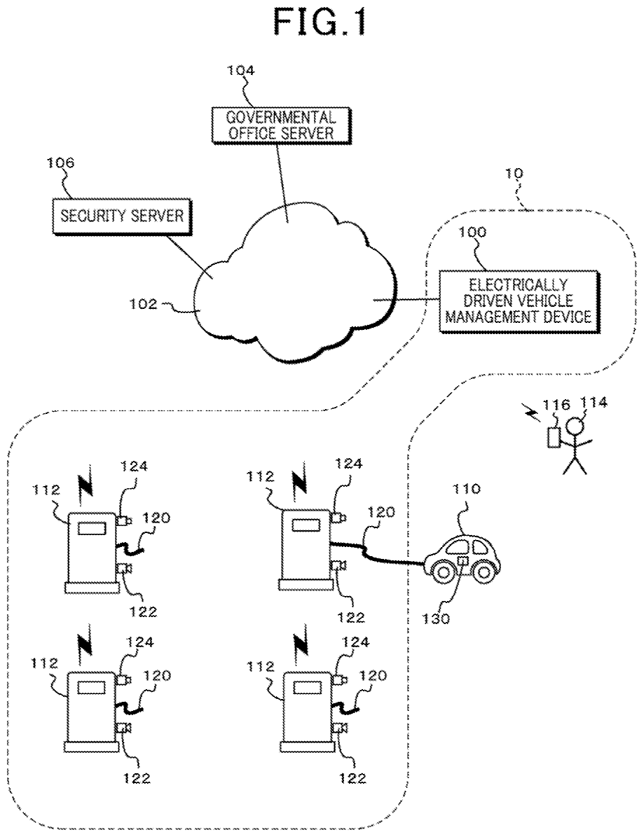

Hereinafter, an embodiment of the present invention will be described with reference to attached drawings. FIG. 1 is a diagram illustrating an exemplary scene (or system) in which an electrically driven vehicle management device 100 according to an embodiment of the present invention is used. The electrically driven vehicle management device 100 is, for example, a server, which is communicably connected to other servers such as a governmental office server 104 operated by an administrative organ such as a tax office or a transportation bureau and/or a security server 106 operated by a police agency or a security company, for example, via a network 102. Here, it is supposed that the network 102 may include, for example, the Internet.

Furthermore, the electrically driven vehicle management device 100 is communicably connected to one or multiple charging devices 112 for charging an electrically driven vehicle 110 and a portable terminal 116 of a user 114 who is, for example, an owner of the electrically driven vehicle 110, via the network 102 or directly without using the network 102. The charging device 112 can be, for example, a charging apparatus disposed in a vehicle charging facility that can be used by any user, or a charging apparatus provided in a parking lot of a store such as a convenience store or a department store. The electrically driven vehicle management device 100 and the charging device 112 cooperatively configure an electrically driven vehicle management system 10.

The charging device 112 includes a charging cable 120 that is attachable to and detachable from the electrically driven vehicle 110. The charging cable 120 configures a power feeding path to the electrically driven vehicle 110 and configures a communication path for communicating with the electrically driven vehicle 110.

The electrically driven vehicle 110 includes a vehicle control device 130. In response to reception of a vehicle information transmission request via the charging cable 120, the vehicle control device 130 transmits its own vehicle inherent information via the charging cable 120. Furthermore, in response to reception of a command via the charging cable 120, the vehicle control device 130 performs an operation corresponding to the received command.

Furthermore, the charging device 112 is provided with a camera 122 that is an imaging device capable of imaging the electrically driven vehicle 110 to which the charging cable 120 (i.e., the charging cable 120 of the charging device 112) is connected. Here, it is supposed that the image of the electrically driven vehicle 110 captured by the camera 122 includes an image of a license plate of the electrically driven vehicle.

The charging device 112 further includes a marking device 124 that can perform marking on the electrically driven vehicle 110, for example, by shooting a color ball filled with dyes that are difficult to remove by washing toward the electrically driven vehicle 110 to which the charging cable 120 is connected.

In the scene illustrated in FIG. 1, first, when the charging cable 120 of the charging device 112 is connected to the electrically driven vehicle 110, the electrically driven vehicle management device 100 acquires vehicle inherent information of the electrically driven vehicle 110. In the present embodiment, the vehicle inherent information is, for example, vehicle identification number (VIN), although this is a mere example. It is supposed that the vehicle inherent information is any information if it is information inherent to the electrically driven vehicle 110, which can be used in individual identification of the electrically driven vehicle 110. The vehicle inherent information is, for example, vehicle body number of the electrically driven vehicle 110 or registration number displayed on the license plate.

Specifically, in response to connection of its own charging cable 120 to the electrically driven vehicle 110, the charging device 112 transmits a cable connection notification for notifying this fact to the electrically driven vehicle management device 100. In response to reception of the cable connection notification, the electrically driven vehicle management device 100 transmits an inherent information transmission request for requesting the vehicle inherent information of the electrically driven vehicle 110 to the charging device 112.

In response to reception of the inherent information transmission request, the charging device 112 acquires the vehicle inherent information of the electrically driven vehicle 110 connected to its own charging cable 120 and transmits the acquired vehicle inherent information to the electrically driven vehicle management device 100. The electrically driven vehicle management device 100 acquires the vehicle inherent information by receiving the vehicle inherent information transmitted by the charging device 112.

Here, the charging device 112 transmits the vehicle information transmission request to the electrically driven vehicle 110, for example, via the charging cable 120, and receives the vehicle inherent information transmitted from the electrically driven vehicle 110 and acquires this.

When the vehicle inherent information is registration number of the electrically driven vehicle 110, the charging device 112 may acquire an image including the license plate of the electrically driven vehicle 110 acquired by the camera 122 or registration number on the license plate extracted from the acquired image, as the vehicle inherent information of the electrically driven vehicle 110.

Next, based on the acquired vehicle inherent information, the electrically driven vehicle management device 100 determines a coping operation to be performed in relation to the electrically driven vehicle 110 presently connected to the charging device 112. This determination is performed, for example, by determining whether the electrically driven vehicle 110 is a tracking target vehicle. Here, tracking target vehicles include non-conforming vehicles and tracking requested vehicles.

The non-conforming vehicle is a vehicle that does not conform with official rules such as laws, ordinances, regulations or does not comply with these rules. Specifically, the non-conforming vehicle is, for example, a stolen vehicle, a tax delinquent vehicle, or a vehicle that has not been legally or voluntarily inspected (a non-inspected vehicle). However, this is a mere example, and it is supposed that the non-conforming vehicles include any vehicles that do not conform or comply with industry rules such as vehicle industry standards, in addition to the official rules.

Furthermore, the tracking requested vehicle is an electrically driven vehicle that a user has requested the electrically driven vehicle management device 100 to track, for example, because the electrically driven vehicle is outside a management range of the user of the electrically driven vehicle. Here, the “outside the management range of the user” is for example a case where the user cannot identify the range in which its own electrically driven vehicle is present, and includes a case where the user lends the electrically driven vehicle to a third party and the third party is driving the electrically driven vehicle beyond the range of user's consent or assumption.

Based on the vehicle inherent information of the electrically driven vehicle 110 acquired from the charging device 112, the electrically driven vehicle management device 100 determines whether the electrically driven vehicle 110 is a non-conforming vehicle, for example, by making an inquiry to the governmental office server 104 or the security server 106. Furthermore, the electrically driven vehicle management device 100 determines whether the electrically driven vehicle 110 is a tracking requested vehicle by confirming whether a tracking request has been received from the portable terminal 116 of the user 114.

Then, when the electrically driven vehicle 110 is a non-conforming vehicle, the electrically driven vehicle management device 100 determines a coping operation to be performed in relation to the electrically driven vehicle 110 according to the type of nonconformity (e.g., stolen vehicle, tax delinquent vehicle, non-inspected vehicle). Specifically, the electrically driven vehicle management device 100 determines the coping operation to be performed in relation to the electrically driven vehicle with reference to a coping operation determined in advance according to the type of nonconformity. Furthermore, in addition to this, the electrically driven vehicle management device 100 may determine the coping operation to be performed in relation to the electrically driven vehicle 110 by confirming whether the electrically driven vehicle 110 is a tracking requested vehicle.

The coping operation to be performed in relation to the electrically driven vehicle 110 may include, for example, transmitting a predetermined command to the electrically driven vehicle 110, inhibiting travel of the electrically driven vehicle 110, reporting to a predetermined reporting destination and/or marking on the electrically driven vehicle 110.

For example, it is supposed that the electrically driven vehicle management device 100 can inhibit the travel of the electrically driven vehicle 110 by transmitting a travel inhibition command to the electrically driven vehicle 110. Furthermore, in the operation to be performed in relation to the electrically driven vehicle 110, it is supposed that the command to be transmitted to the electrically driven vehicle 110 can include an alarm issuance command for causing an alarm device of the electrically driven vehicle 110 to generate alarm sound, a light emission instruction command for causing a light emission device (lamp) such as head lamp, vehicle width lamp, tail lamp, or direction indicator lamp of the electrically driven vehicle 110 to emit light, and/or a positional information request command for requesting transmission of positional information indicating the present location of the electrically driven vehicle 110, in addition to the travel inhibition command.

Furthermore, the reporting to a predetermined reporting destination may include, for example, reporting to a predetermined administrative organ via the governmental office server 104, or reporting to a police agency or a security company that operates the security server 106, or reporting to the portable terminal 116 designated in advance by the user 114.

It is supposed that the coping operation to be performed in relation to the electrically driven vehicle 110, which is determined according to the type of nonconformity of the electrically driven vehicle 110 being a non-conforming vehicle, can be stored in advance in the electrically driven vehicle management device 100 in association with the type of nonconformity.

Through the above operations, since the vehicle inherent information of the electrically driven vehicle 110 can be acquired via the charging device 112 that the electrically driven vehicle 110 uses for traveling, even when the electrically driven vehicle 110 is not equipped with TCU and has no remote communication function, the electrically driven vehicle management device 100 can find out the electrically driven vehicle 110 and perform a desired coping operation relevant to the electrically driven vehicle 110, such as transmission of the travel inhibition command to the electrically driven vehicle 110 or marking on this vehicle.

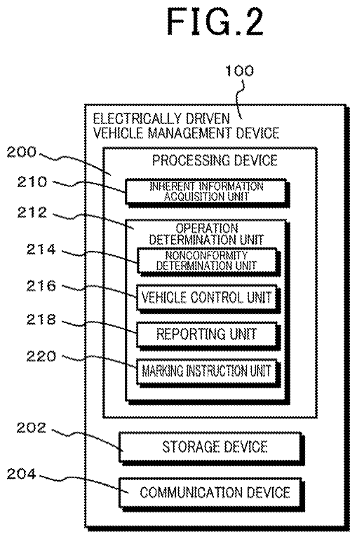

FIG. 2 is a diagram illustrating an exemplary configuration of the electrically driven vehicle management device 100. The electrically driven vehicle management device 100 is, for example, located in a charging facility in which the charging device 112 is disposed, or located at a remote place away from such a charging facility.

The electrically driven vehicle management device 100 includes a processing device 200, a storage device 202, and a communication device 204. The storage device 202 is, for example, configured by a volatile semiconductor memory, a nonvolatile semiconductor memory, or a hard disk device, which stores data and/or program necessary for operations of the processing device 200. The communication device 204 is a transmitter/receiver that performs wireless communications and/or wired communications, and communicably connects the processing device 200 to the governmental office server 104, the security server 106, and the portable terminal 116 of the user 114, for example, via the network 102. Furthermore, the communication device 204 communicably connects the processing device 200 to the charging device 112 indirectly via the network 102, or directly without using the network 102.

The processing device 200 is, for example, a computer including a processor such as a central processing unit (CPU). The processing device 200 may be configured to include a read only memory (ROM) in which programs are written and a random access memory (RAM) for temporary storage of data. The processing device 200 includes, as functional elements or functional units, an inherent information acquisition unit 210 and an operation determination unit 212. Furthermore, the operation determination unit 212 includes a nonconformity determination unit 214, a vehicle control unit 216, a reporting unit 218, and a marking instruction unit 220.

These functional elements included in the processing device 200 can be realized, for example, when the processing device 200 being a computer executes programs. The computer programs can be stored in any computer-readable storage medium. Alternatively, the whole or a part of the functional elements included in the processing device 200 can be configured by hardware including one or more electronic circuit components.

When the charging cable 120 of any one of the charging devices 112 is connected to the electrically driven vehicle 110, the inherent information acquisition unit 210 acquires the vehicle inherent information that can be used in identifying the electrically driven vehicle 110. For example, when the cable connection notification informing that the charging cable 120 has been connected to the electrically driven vehicle 110 is received from any one of the charging devices 112, the inherent information acquisition unit 210 receives and acquires the vehicle inherent information of the electrically driven vehicle 110 from the charging device 112 by transmitting the inherent information transmission request to the charging device 112.

Based on the vehicle inherent information acquired by the inherent information acquisition unit 210, the operation determination unit 212 determines the coping operation to be performed in relation to the electrically driven vehicle 110 to which the charging cable 120 is connected. As described above, this coping operation may include transmitting a predetermined command to the electrically driven vehicle 110, inhibiting travel of the electrically driven vehicle 110, reporting to a predetermined reporting destination, and/or marking on the electrically driven vehicle 110.

Specifically, based on the vehicle inherent information, the nonconformity determination unit 214 of the operation determination unit 212 determines whether the electrically driven vehicle 110 having the vehicle inherent information is a tracking target vehicle. In the case of the tracking target vehicle, the nonconformity determination unit 214 checks the possibility of a non-conforming vehicle. Then, when the electrically driven vehicle 110 is a non-conforming vehicle, the nonconformity determination unit 214 determines the type of nonconformity and determines the coping operation to be performed for the electrically driven vehicle 110 with reference to a coping operation determined in advance according to the type of nonconformity.

It is supposed that the coping operation determined in advance according to the type of nonconformity can be stored, for example, in the storage device 202 beforehand. Furthermore, it is supposed that the determining whether the electrically driven vehicle 110 is a tracking target vehicle and a non-conforming vehicle can be performed by the nonconformity determination unit 214, for example, by making an inquiry to the governmental office server 104 and/or the security server 106 based on the vehicle inherent information.

More specifically, it is supposed that the nonconformity determination unit 214 can determine whether the electrically driven vehicle 110 is a tax delinquent vehicle or a non-inspected vehicle by making an inquiry to the governmental office server 104 based on the vehicle inherent information. Thus, the nonconformity determination unit 214 can determine that the electrically driven vehicle 110 is a non-conforming vehicle being a tracking target vehicle and the type of nonconformity is a tax delinquent vehicle or a non-inspected vehicle.

Furthermore, the nonconformity determination unit 214 can determine whether the electrically driven vehicle 110 is a stolen vehicle by making an inquiry to the security server 106 based on the vehicle inherent information. Thus, the nonconformity determination unit 214 can determine that the electrically driven vehicle 110 is a non-conforming vehicle being a tracking target vehicle and the type of nonconformity is a stolen vehicle.

Furthermore, it is supposed that the nonconformity determination unit 214 can determine whether the electrically driven vehicle 110 is a tracking requested vehicle, for example, based on a tracking request received from the portable terminal 116 of the user 114. It is supposed that the tracking request received from the portable terminal 116 can include vehicle inherent information of the target vehicle to be subjected to the tracking (i.e., the tracking requested vehicle) and communication address of the portable terminal 116. Furthermore, it is supposed that the received tracking request can be stored in the storage device 202 by the processing device 200, for example, together with the reception date and time.

When the coping operation to be performed in relation to the electrically driven vehicle 110 determined by the nonconformity determination unit 214 is accompanied by a vehicle operation, the vehicle control unit 216 of the operation determination unit 212 instructs the charging device 112 to transmit a command for causing the electrically driven vehicle 110 to perform the coping operation.

For example, when the coping operation determined by the nonconformity determination unit 214 is inhibiting travel of the electrically driven vehicle 110, the vehicle control unit 216 transmits an instruction to transmit the travel inhibition command to the electrically driven vehicle 110 to the charging device 112 via the communication device 204.

Furthermore, for example, when the coping operation determined by the nonconformity determination unit 214 is issuance of alarm sound or lighting of lamp in the electrically driven vehicle 110, the vehicle control unit 216 transmits a transmission instruction of an alarm command or a light emission instruction command of a corresponding lamp (e.g., head lamp, vehicle width lamp, tail lamp, direction indicator lamp) to the charging device 112 via the communication device 204.

When the coping operation determined by the nonconformity determination unit 214 is reporting to a predetermined reporting destination, the reporting unit 218 of the operation determination unit 212 reports the fact that the electrically driven vehicle 110 has been found out to a predetermined reporting destination determined in advance for the type of nonconformity or the electrically driven vehicle 110. It is supposed that this reporting can include positional information about the present location of the electrically driven vehicle 110. The positional information can be acquired via the charging device 112, for example, when the reporting unit 218 transmits an instruction to transmit the positional information request command to the electrically driven vehicle 110 to the charging device 112 directly or indirectly via the vehicle control unit 216.

Here, it is supposed that the “predetermined reporting destination” is determined in advance in association with the type of nonconformity and/or the vehicle inherent information and stored in the storage device 202, or stored in the storage device 202 upon reception of a tracking request from the portable terminal 116 of the user 114. For example, it is supposed that, when the tracking request is received from the portable terminal 116, the processing device 200 can store communication address of the portable terminal 116 included in the tracking request, as a reporting destination for a corresponding tracking requested vehicle, in the storage device 202.

When the coping operation determined by the nonconformity determination unit 214 is marking on the electrically driven vehicle 110, the marking instruction unit 220 of the operation determination unit 212 transmits, to the charging device 112, a marking execution instruction for causing the marking device 124 equipped in the charging device 112 to perform marking on the electrically driven vehicle 110. When the charging device 112 has received the marking execution instruction, the marking device 124 performs marking on the electrically driven vehicle 110, for example, by shooting the above-described color ball toward the electrically driven vehicle 110.

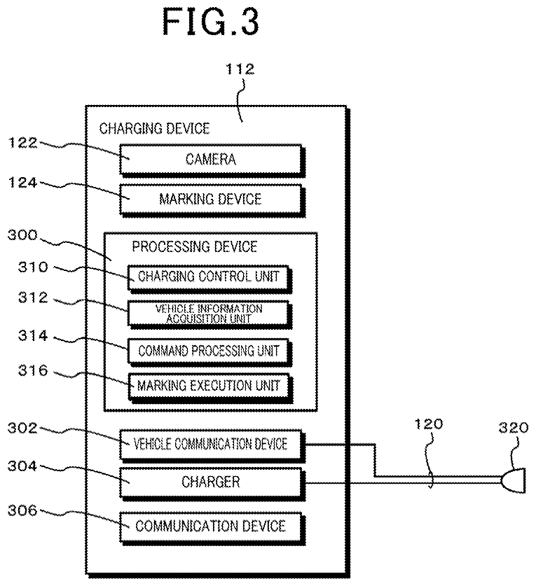

Next, the configuration of the charging device 112 will be described. FIG. 3 is a diagram illustrating an exemplary configuration of the charging device 112. The charging device 112 includes a processing device 300, a vehicle communication device 302, a charger 304, and a communication device 306, in addition to the camera 122 and the marking device 124.

Under the control of the processing device 300, the charger 304 charges a storage battery 414 (described below) of the electrically driven vehicle 110 connected to the charging cable 120 configuring the power feeding path. The vehicle communication device 302 is a transmitter/receiver for communicably connecting the processing device 300 to the electrically driven vehicle 110 via the charging cable 120.

The communication device 306 is a transmitter/receiver that communicably connects the processing device 300 to the electrically driven vehicle management device 100 indirectly via the network 102 or directly without using the network 102.

The processing device 300 is, for example, a computer including a processor such as a CPU. The processing device 300 may be configured to have a ROM in which programs are written and a RAM for temporarily storing data. Furthermore, the processing device 300 includes, as functional elements or functional units, a charging control unit 310, a vehicle information acquisition unit 312, a command processing unit 314, and a marking execution unit 316.

These functional elements included in the processing device 300 can be realized, for example, when the processing device 300 being a computer executes programs. The computer programs can be stored in any computer-readable storage medium. Alternatively, the whole or a part of the functional elements included in the processing device 300 can be configured by hardware including one or more electronic circuit components.

The charging control unit 310 controls the operation of the charger 304 that charges the electrically driven vehicle 110.

The vehicle information acquisition unit 312 acquires vehicle inherent information from the electrically driven vehicle 110 via the vehicle communication device 302 and the charging cable 120 and transmits the acquired vehicle inherent information to the electrically driven vehicle management device 100. Specifically, first, when connection of a connector 320 of the charging cable 120 to the electrically driven vehicle 110 is detected, the vehicle information acquisition unit 312 transmits, to the electrically driven vehicle management device 100, a cable connection notification to which an identification code for identifying itself is attached. This detection can be performed, for example, by checking a connection response returned from the electrically driven vehicle 110 connected to the connector 320 when the vehicle information acquisition unit 312 outputs probe signals to the charging cable 120 via the vehicle communication device 302 at predetermined time intervals.

Subsequently, in response to reception of the inherent information transmission request from the electrically driven vehicle management device 100, the vehicle information acquisition unit 312 transmits a vehicle information transmission request to the electrically driven vehicle 110 via the vehicle communication device 302 and the charging cable 120, and receives and acquires vehicle inherent information from the electrically driven vehicle 110. Then, the vehicle information acquisition unit 312 transmits the acquired vehicle inherent information to the electrically driven vehicle management device 100 via the communication device 306.

In response to reception of an instruction from the electrically driven vehicle management device 100, the command processing unit 314 transmits a command to the electrically driven vehicle 110, and when data according to the command is received from the electrically driven vehicle 110, transmits the received data to the electrically driven vehicle management device 100.

Specifically, in response to reception of a transmission instruction of the travel inhibition command from the electrically driven vehicle management device 100, the command processing unit 314 transmits the travel inhibition command to the electrically driven vehicle 110 via the vehicle communication device 302 and the charging cable 120. Furthermore, in response to reception of a transmission instruction of the alarm issuance command and a transmission instruction of the light emission instruction command from the electrically driven vehicle management device 100, the command processing unit 314 transmits the alarm issuance command and the light emission instruction command to the electrically driven vehicle 110 via the vehicle communication device 302 and the charging cable 120.

Furthermore, in response to reception of a transmission instruction of the positional information request command from the electrically driven vehicle management device 100, the command processing unit 314 transmits the positional information request command to the electrically driven vehicle 110 via the vehicle communication device 302 and the charging cable 120. Furthermore, the command processing unit 314 receives positional information output by the electrically driven vehicle 110 in response to reception of the positional information request command and transmits the received positional information to the electrically driven vehicle management device 100.

In response to reception of a marking execution instruction from the electrically driven vehicle management device 100, the marking execution unit 316 instructs the marking device 124 to perform marking on the electrically driven vehicle 110. As described above, the marking device 124 can perform marking, for example, by shooting a color ball toward the electrically driven vehicle 110.

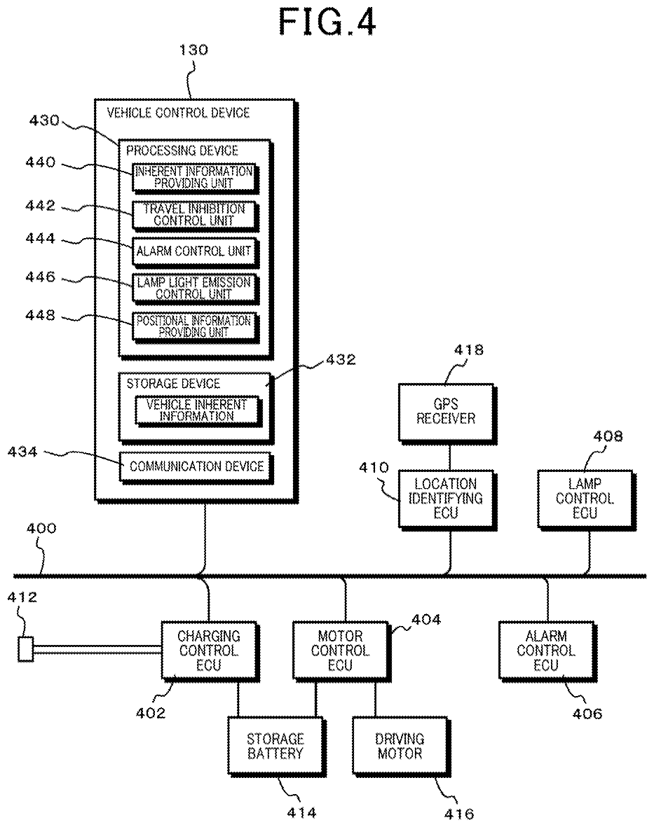

Next, the configuration of the vehicle control device 130 included in the electrically driven vehicle 110 will be described. FIG. 4 is a diagram illustrating an exemplary configuration of the vehicle control device 130. The vehicle control device 130 is, for example, as an electronic control unit (ECU), which is communicably connected to another ECU such as a charging control ECU 402, a motor control ECU 404, an alarm control ECU 406, a lamp control ECU 408, and a location identifying ECU 410, via an on-vehicle network bus 400 that configures, for example, a control area network (CAN) communication network.

Here, the charging control ECU 402 controls the charging operation of the storage battery 414 of the host vehicle by feeding electric power from the charging device 112 using the charging cable 120 connected to a connector 412. Furthermore, the charging control ECU 402 functions as a communication device that communicates with the charging device 112 via the charging cable 120. The vehicle control device 130 can transmit transmission data to the charging device 112 via the charging control ECU 402 by transmitting a transmission instruction and the transmission data to the charging control ECU 402 via the on-vehicle network bus 400. Furthermore, the vehicle control device 130 can receive commands, data and the like transmitted from the charging device 112 to its own device via the charging control ECU 402 and the on-vehicle network bus 400.

The storage battery 414 drives a driving motor 416 that drives wheels of the electrically driven vehicle 110 being the host vehicle. The motor control ECU 404 controls the drive operation of the driving motor 416 by the storage battery 414.

The alarm control ECU 406 and the lamp control ECU 408 respectively control the operation of the alarm device such as a horn of the electrically driven vehicle 110 being the host vehicle and lighting of lamps such as the head lamp, the tail lamp, the vehicle width lamp, and the direction indicator lamp.

The location identifying ECU 410 identifies the present location of the electrically driven vehicle 110 being the host vehicle from GPS waves received from a GPS receiver 418.

The vehicle control device 130 includes a processing device 430, a storage device 432, and a communication device 434. The storage device 432 includes, for example, a nonvolatile memory, in which the vehicle inherent information of the electrically driven vehicle 110 on which the vehicle control device 130 is mounted is stored in advance.

The communication device 434 is a transmitter/receiver that communicably connects the vehicle control device 130 to another ECU such as the charging control ECU 402 connected to the on-vehicle network bus 400. For example, when the on-vehicle network bus 400 is a CAN bus that conforms with CAN communication standards, the communication device 434 is a CAN transceiver that performs transmission and reception in conformity with the CAN communication standards.

The processing device 430 is, for example, a computer including a processor such as a CPU. The processing device 430 may be configured to have a ROM in which programs are written and a RAM for temporarily storing data. Furthermore, the processing device 430 includes, as functional elements or functional units, an inherent information providing unit 440, a travel inhibition control unit 442, an alarm control unit 444, a lamp light emission control unit 446, and a positional information providing unit 448.

These functional elements included in the processing device 430 can be realized, for example, when the processing device 430 being a computer executes programs. The computer programs can be stored in any computer-readable storage medium. Alternatively, the whole or a part of the functional elements included in the processing device 430 can be configured by hardware including one or more electronic circuit components.

In response to reception of a vehicle information transmission request from the charging device 112 via the charging control ECU 402, the inherent information providing unit 440 reads the vehicle inherent information stored in the storage device 432 and transmits the read vehicle inherent information to the charging device 112 via the charging control ECU 402.

In response to reception of a travel inhibition command from the charging device 112 via the charging control ECU 402, the travel inhibition control unit 442 transmits an energization prohibition command for prohibiting electric power supply from the storage battery 414 to the driving motor 416 to the motor control ECU 404. In response to reception of the energization prohibition command, the motor control ECU 404 cuts off the power supply from the storage battery 414 to the driving motor 416 and maintains the energization cut-off state even when a user performs an accelerator operation or the like.

Alternatively or in addition to this, it is supposed that when receiving the travel inhibition command the travel inhibition control unit 442 can instruct a brake control ECU (not illustrated) connected to the on-vehicle network bus 400 to bring the brake of the electrically driven vehicle 110 being the host vehicle into a locked state and can maintain the locked state even when a user performs a brake release operation.

In response to reception of the alarm issuance command from the charging device 112 via the charging control ECU 402, the alarm control unit 444 instructs the alarm control ECU 406 to cause the alarm device (not illustrated) of the electrically driven vehicle 110 being the host vehicle to generate alarm sound.

In response to reception of the light emission instruction command for instructing light emission of the light emission device (not illustrated) such as the head lamp, the tail lamp, the vehicle width lamp, or the direction indicator lamp from the charging device 112 via the charging control ECU 402, the lamp light emission control unit 446 instructs the lamp control ECU 408 to cause the corresponding light emission device to emit light.

In response to reception of the positional information request command from the charging device 112 via the charging control ECU 402, the positional information providing unit 448 acquires information about the present location of the electrically driven vehicle 110 being the host vehicle from the location identifying ECU 410. Then, the positional information providing unit 448 transmits positional information including the present location information to the charging device 112 via the charging control ECU 402.

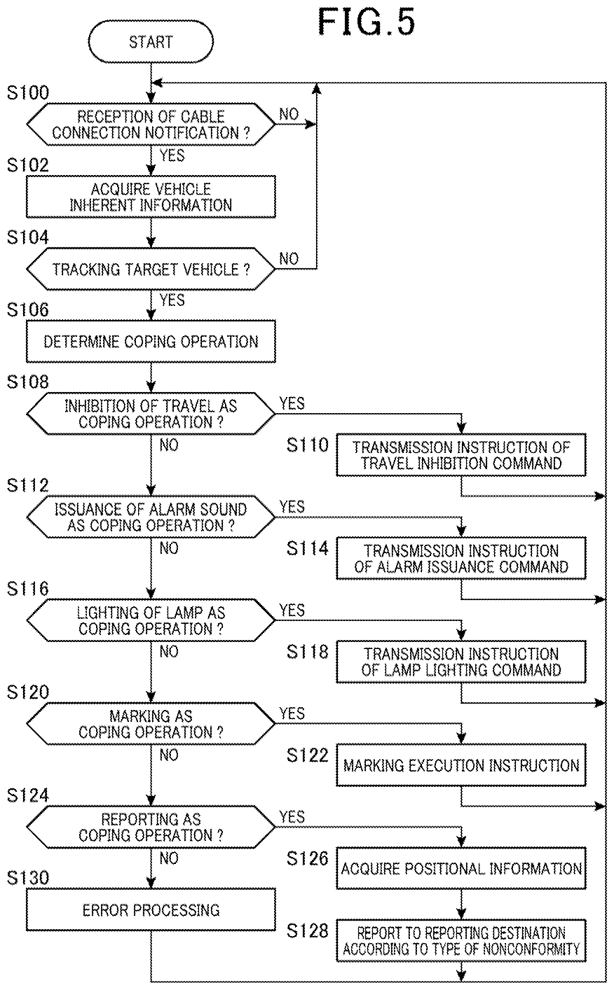

Next, the operation of the electrically driven vehicle management device 100 will be described. FIG. 5 is a flow chart illustrating an operation procedure of the electrically driven vehicle management device 100. The processing illustrated in FIG. 5 starts, for example, when the electrically driven vehicle management device 100 is turned on and terminates when turned off.

When the processing is started, first, the inherent information acquisition unit 210 included in the processing device 200 of the electrically driven vehicle management device 100 determines whether the cable connection notification has been received from any one of the charging devices 112 (step S100). Then, if no cable connection notification has been received from any one of the charging devices 112 (NO in step S100), the inherent information acquisition unit 210 returns to the processing in step S100 and waits until the cable connection notification is received from any one of the charging devices 112.

On the other hand, the cable connection notification has been received from any one of the charging devices 112 (YES in step S100), the inherent information acquisition unit 210 acquires, from the charging device 112 being a transmission source of the cable connection notification (hereinafter, simply referred to as the charging device 112 in the description of FIG. 5), the vehicle inherent information of the electrically driven vehicle 110 connected to the charging device 112 (step S102).

Next, the nonconformity determination unit 214 of the electrically driven vehicle management device 100 determines whether the electrically driven vehicle 110 indicated by the vehicle inherent information is a tracking target vehicle (i.e., a non-conforming vehicle or a tracking requested vehicle) based on the acquired vehicle inherent information (step S104). Then, if the electrically driven vehicle 110 is not a tracking target vehicle (NO in step S104), the processing device 200 repeats the processing in step S100. On the other hand, when the electrically driven vehicle 110 is a tracking target vehicle (YES in step S104), the nonconformity determination unit 214 determines a coping operation to be performed in relation to the electrically driven vehicle 110 by checking whether tracking target vehicle is a tracking requested vehicle and/or according to the level of nonconformity when the tracking target vehicle is a non-conforming vehicle (step S106).

Then, the vehicle control unit 216 determines whether the determined coping operation is inhibition of travel (step S108), and in the case of inhibition of travel (YES in step S108), transmits a transmission instruction of the travel inhibition command to the charging device 112 (step S110). Subsequently, the processing device 200 repeats the processing in step S100.

On the other hand, when the determined coping operation is not the inhibition of travel (NO in step S108), the vehicle control unit 216 determines whether the coping operation is issuance of alarm sound (step S112). Then, if the coping operation is issuance of alarm sound (YES in step S112), the vehicle control unit 216 transmits a transmission instruction of the alarm issuance command to the charging device 112 (step S114). Subsequently, the processing device 200 returns to step S100 and repeats the processing in step S100.

On the other hand, when the coping operation is not the issuance of alarm sound (NO in step S112), the vehicle control unit 216 determines whether the coping operation is lighting of lamp (step S116). Then, when the coping operation is lighting of lamp (YES in step S116), the vehicle control unit 216 transmits a transmission instruction of the lamp lighting command to the charging device 112 (step S118). Subsequently, the processing device 200 returns to step S100 and repeats the processing in step S100.

On the other hand, when the coping operation is not the lighting of lamp (NO in step S116), the marking instruction unit 220 determines whether the coping operation is marking on the electrically driven vehicle 110 (step S120). Then, when the coping operation is marking (YES in step S120), the marking instruction unit 220 transmits a marking execution instruction to the charging device 112 (step S122). Subsequently, the processing device 200 returns to step S100 and repeats the processing in step S100.

On the other hand, when the coping operation is not the marking (NO in step S120), the reporting unit 218 determines whether the coping operation is reporting to a predetermined reporting destination (step S124). Then, when the coping operation is the reporting (YES in step S124), the reporting unit 218 acquires positional information indicating the present location from the electrically driven vehicle 110 connected to the charging device 112 (step S126), and reports the report including the positional information to the predetermined reporting destination for the electrically driven vehicle (step S128). Subsequently, the processing device 200 returns to step S100 and repeats the processing in step S100.

On the other hand, when the coping operation is not the reporting (NO in step S124), the coping operation is uncertain. Therefore, the operation determination unit 212 performs predetermined error processing (step S130). It is supposed that the error processing can include, for example, reporting to an administrator of the electrically driven vehicle management device 100. Subsequently, the processing device 200 returns to step S100 and repeats the processing in step S100.

The present invention is not limited to the configuration of the above-described embodiment, and can be implemented in various aspects in the range that does not derive from the gist thereof.

For example, although the charging device 112 is configured to transmit a command or the like to the electrically driven vehicle 110 via the charging cable 120 configuring the communication path and receive the vehicle inherent information or the like from the electrically driven vehicle 110, the present invention is not limited to the above-described embodiment. For example, the charging device 112 and the electrically driven vehicle 110 may communicate with each other via short-range wireless communication such as NFC or Bluetooth (registered trademark). For example, the charging device 112 may be configured to establish short-range wireless communication with the electrically driven vehicle 110 when the electrically driven vehicle 110 stops at a charging location for charging from the charging device 112 and configured to transmit a command or the like to the electrically driven vehicle 110 and receive the vehicle inherent information or the like from the electrically driven vehicle 110.

For example, in the above-described embodiment, although the exemplary coping operation to be executed for the electrically driven vehicle 110 is any one of inhibition of travel, issuance of alarm sound, lighting of lamp, marking, and reporting, the present invention is not limited to the above-described embodiment. For example, an appropriate combination of these coping operations may be executed for a single electrically driven vehicle 110. Furthermore, in addition to these coping operations or in place of any one of these coping operations, it is possible to include any other desired coping operation, such as locking the connection state of the charging cable 120 with the electrically driven vehicle 110, holding the door locked state of the electrically driven vehicle 110, holding the steering locked state, collecting the traveling history, or acquiring face images of a driver and occupants.

Furthermore, in addition to the above-described coping operations or in place of any one of these coping operations, electric power remaining in the storage battery 414 may be reduced by causing the storage battery 414 of the electrically driven vehicle 110 to discharge toward the charging device 112. For example, when the electrically driven vehicle 110 is configured to be able to perform a so-called Vehicle to Grid (V2G) operation or a Vehicle to Home (V2H) operation, the electrically driven vehicle management device 100 can instruct the charging device 112 to transmit a command for performing the V2G operation or the V2H operation to the electrically driven vehicle 110, thereby causing the storage battery 414 of the electrically driven vehicle 110 to discharge via the charging cable 120. The electrically driven vehicle management device 100 can bring the corresponding electrically driven vehicle 110 into a traveling difficult or traveling infeasible state, for example, by performing the above-mentioned discharge in addition to or as a part of the inhibition of travel.

Furthermore, in the above-described embodiment, when the coping operation is inhibition of travel, the charging device 112 transmits the travel inhibition command to the electrically driven vehicle 110 according to an instruction from the electrically driven vehicle management device 100, thereby prohibiting the traveling of the electrically driven vehicle 110. However, the present invention is not limited to the above-described embodiment. Alternatively or in addition to this, a lock mechanism (e.g., a so-called lock plate or flap plate used in a coin-operated parking) capable of preventing the electrically driven vehicle 110 from moving may be provided at a stop space of the electrically driven vehicle 110 connected to the charging device 112, and the charging device 112 may activate the lock mechanism in response to the instruction from the electrically driven vehicle management device 100, so that the electrically driven vehicle 110 is prevented from traveling.

Furthermore, in the above-described embodiment, the electrically driven vehicle management device 100 determines whether the electrically driven vehicle 110 relating to the vehicle inherent information is a non-conforming vehicle by making an inquiry to the governmental office server 104 or the security server 106 based on the acquired vehicle inherent information. However, the present invention is not limited to the above-described embodiment. Alternatively, the administrative organ, the police, or the security company may be configured to register (for example, store in the storage device 202 of the electrically driven vehicle management device 100) search information associating vehicle inherent information of the electrically driven vehicle 110 to be found with designation of a coping operation at the time of finding, to the electrically driven vehicle management device 100, for example, via an appropriate server such as the governmental office server 104 and/or the security server 106. In this case, it is supposed that the electrically driven vehicle management device 100 can acquire the vehicle inherent information of the electrically driven vehicle 110 via the charging device 112 and then determine the coping operation according to the registered search information.

As described above, the electrically driven vehicle management device 100 according to the present embodiment includes the inherent information acquisition unit 210 and the operation determination unit 212. When the charging cable 120 attachable to and detachable from the electrically driven vehicle 110 is connected to the electrically driven vehicle 110, the inherent information acquisition unit 210 acquires the vehicle inherent information that can be used in identifying the electrically driven vehicle 110. Furthermore, based on the acquired vehicle inherent information, the operation determination unit 212 determines the coping operation to be performed in relation to the electrically driven vehicle 110 to which the charging cable 120 is connected.

According to this configuration, it is possible to acquire the vehicle inherent information of the electrically driven vehicle 110 via the charging device 112 to which the electrically driven vehicle 110 may be connected as it travels, and it is possible to identify the electrically driven vehicle 110 from the vehicle inherent information and perform a predetermined coping operation. Accordingly, even if the electrically driven vehicle 110 is a vehicle having no remote communication function, it is possible to find out the electrically driven vehicle 110 and perform a desired coping operation such as reporting or inhibition of travel.

Furthermore, in the electrically driven vehicle management device 100, the operation determination unit 212 determines whether the electrically driven vehicle 110 having the vehicle inherent information is a tracking target vehicle based on the vehicle inherent information, and when the electrically driven vehicle 110 is a tracking target vehicle, determines the coping operation to be performed in relation to the electrically driven vehicle 110.

According to this configuration, since processing is performed only for the electrically driven vehicle to be tracked determined from the vehicle inherent information, it is possible to reduce the load of the electrically driven vehicle management device 100 and perform efficient electrically driven vehicle tracking.

Furthermore, in the electrically driven vehicle management device 100, the tracking target vehicle includes a non-conforming vehicle that does not conform with a predetermined rule or does not comply with a predetermined rule, and the operation determination unit 212 determines the coping operation to be performed in relation to the electrically driven vehicle 110 with reference to the type of nonconformity.

According to this configuration, even if the electrically driven vehicle 110 has no remote communication function, when the electrically driven vehicle 110 is an illegal non-conforming vehicle, it is possible to perform an appropriate coping operation on the electrically driven vehicle 110 being the non-conforming vehicle according to the type or degree of illegality.

Furthermore, in the electrically driven vehicle management device 100, the type of nonconformity includes stolen vehicle, tax delinquent vehicle, or non-inspected vehicle. According to this configuration, it is possible to promote early detection and coping of not only stolen vehicles but also various non-conforming vehicles such as tax delinquent vehicles and non-inspected vehicles.

Furthermore, in the electrically driven vehicle management device 100, the coping operation to be performed in relation to the electrically driven vehicle 110 includes reporting to a predetermined reporting destination and/or inhibition of travel of the electrically driven vehicle 110. According to this configuration, information about the found non-conforming or tracking requested vehicle can be immediately reported to a pertinent agency or to a tracking requester, and/or since the location of such a vehicle is fixed, the pertinent agency or the tracking requester can quickly and/or surely take desired secondary measures such as capturing of a thief or securing of the non-conforming vehicle.

Furthermore, in the electrically driven vehicle management device 100, the charging cable 120 configures the power feeding path to the electrically driven vehicle 110 and also configures the communication path with the electrically driven vehicle 110, and the inherent information acquisition unit 210 acquires the vehicle inherent information received from the electrically driven vehicle 110 via the charging cable 120. According to this configuration, the vehicle inherent information can be simply acquired from the electrically driven vehicle 110 without requiring an additional device or apparatus.

Furthermore, in the electrically driven vehicle management device 100, the inherent information acquisition unit 210 can acquire an image capturing the electrically driven vehicle 110 to which the charging cable 120 is connected, as the vehicle inherent information of the electrically driven vehicle 110. According to this configuration, even if the electrically driven vehicle 110 does not support the communication of the vehicle inherent information via the charging cable 120, the vehicle inherent information about the electrically driven vehicle 110 can be simply acquired.

Furthermore, the electrically driven vehicle management device 100 configures the electrically driven vehicle management system 10 together with the charging device 112 equipped with at least one of the vehicle information acquisition unit 312 and the command processing unit 314 communicably connected to the electrically driven vehicle management device 100. Here, in response to reception of an instruction from the electrically driven vehicle management device 100, the vehicle information acquisition unit 312 of the charging device 112 acquires the vehicle inherent information of the electrically driven vehicle 110. Furthermore, in response to reception of an instruction from the electrically driven vehicle management device 100, the command processing unit 314 of the charging device 112 transmits a command to the electrically driven vehicle 110.

According to this configuration, the electrically driven vehicle management device 100 can cooperate with the charging device 112 including vehicle inherent information acquisition means and coping operation execution means to effectively find out a tracking target vehicle having no remote communication function and execute a coping operation.

Furthermore, the electrically driven vehicle management device 100 executes the electrically driven vehicle management method for finding out the specific electrically driven vehicle 110 and determining the coping operation. The electrically driven vehicle management method includes acquiring the vehicle inherent information that can be used in identifying the electrically driven vehicle 110 for the electrically driven vehicle 110 to which the charging cable 120 is connected, and determining a coping operation to be performed in relation to the electrically driven vehicle. The acquiring can be executed by the inherent information acquisition unit 210 when the charging cable 120 attachable to and detachable from the electrically driven vehicle 110 is connected to the electrically driven vehicle 110. Furthermore, the determining can be executed by the operation determination unit 212 based on the acquired vehicle inherent information in the acquiring.

According to this configuration, the vehicle inherent information of the electrically driven vehicle 110 can be acquired via the charging device 112 to which the electrically driven vehicle 110 may be connected as it travels. The electrically driven vehicle 110 can be identified from the vehicle inherent information and a predetermined coping operation can be performed. Accordingly, even if the electrically driven vehicle 110 has no remote communication function, it is possible to find out the electrically driven vehicle and take a desired measure such as reporting or inhibition of travel.

### REFERENCE SIGNS LIST

10 . . . electrically driven vehicle management system, 100 . . . electrically driven vehicle management device, 102 . . . network, 104 . . . governmental office server, 106 . . . security server, 110 . . . electrically driven vehicle, 112 . . . charging device, 114 . . . user, 116 . . . portable terminal, 120 . . . charging cable, 122 . . . camera, 124 . . . marking device, 130 . . . vehicle control device, 200, 300, 430 . . . processing device, 202, 432 . . . storage device, 204, 306, 434 . . . communication device, 210 . . . inherent information acquisition unit, 212 . . . operation determination unit, 214 . . . nonconformity determination unit, 216 . . . vehicle control unit, 218 . . . reporting unit, 220 . . . marking instruction unit, 302 . . . vehicle communication device, 304 . . . charger, 310 . . . charging control unit, 312 . . . vehicle information acquisition unit, 314 . . . command processing unit, 316 . . . marking execution unit, 320, 412 . . . connector, 400 . . . on-vehicle network bus, 402 . . . charging control ECU, 404 . . . motor control ECU, 406 . . . alarm control ECU, 408 . . . lamp control ECU, 410 . . . location identifying ECU, 414 . . . storage battery, 416 . . . driving motor, 418 . . . GPS receiver, 440 . . . inherent information providing unit, 442 . . . travel inhibition control unit, 444 . . . alarm control unit, 446 . . . lamp light emission control unit, 448 . . . positional information providing unit

What is claimed is:

1. An electrically driven vehicle management device comprising:
an inherent information acquisition unit configured to acquire vehicle inherent information that can be used in identifying an electrically driven vehicle when a charging cable attachable to and detachable from the electrically driven vehicle is connected to the electrically driven vehicle,
an operation determination unit configured to determine, based on the acquired vehicle inherent information, a coping operation to be performed in relation to the electrically driven vehicle to which the charging cable is connected.

2. The electrically driven vehicle management device according to claim 1, wherein the operation determination unit determines whether the electrically driven vehicle having the vehicle inherent information is a tracking target vehicle based on the vehicle inherent information, and determines the coping operation to be performed in relation to the electrically driven vehicle when the electrically driven vehicle is the tracking target vehicle.

3. The electrically driven vehicle management device according to claim 2, wherein the tracking target vehicle includes a non-conforming vehicle that does not conform with a predetermined rule or does not comply with a predetermined rule, and the operation determination unit determines the coping operation to be performed in relation to the electrically driven vehicle according to the type of nonconformity.

4. The electrically driven vehicle management device according to claim 3, wherein the type of nonconformity includes stolen vehicle, tax delinquent vehicle, or non-inspected vehicle.

5. The electrically driven vehicle management device according to claim 1, wherein the coping operation to be performed in relation to the electrically driven vehicle includes reporting to a predetermined reporting destination, and/or inhibition of travel of the electrically driven vehicle.

6. The electrically driven vehicle management device according to claim 1, wherein the charging cable configures a power feeding path to the electrically driven vehicle and configures a communication path with the electrically driven vehicle, and the inherent information acquisition unit acquires the vehicle inherent information received from the electrically driven vehicle via the charging cable.

7. The electrically driven vehicle management device according to claim 1, wherein the inherent information acquisition unit acquires, as the vehicle inherent information of the electrically driven vehicle, an image capturing the electrically driven vehicle to which the charging cable is connected.

8. An electrically driven vehicle management system, comprising:
an electrically driven vehicle management device according to claim 1; and
at least one charging apparatus communicably connected to the electrically driven vehicle management device,
wherein the charging apparatus includes
a vehicle information acquisition unit configured to acquire vehicle inherent information of the electrically driven vehicle in response to reception of an instruction from the electrically driven vehicle management device, and
a command processing unit configured to transmit a command to the electrically driven vehicle in response to reception of an instruction from the electrically driven vehicle management device.

9. An electrically driven vehicle management method performed by an electrically driven vehicle management device that finds out an electrically driven vehicle and determines a coping operation, the method comprising:
causing an inherent information acquisition unit to acquire vehicle inherent information that can be used in identifying the electrically driven vehicle to which a charging cable is connected, when the charging cable attachable to and detachable from the electrically driven vehicle is connected to the electrically driven vehicle; and
causing an operation determination unit to determine, based on the acquired vehicle inherent information in the acquiring, a coping operation to be performed in relation to the electrically driven vehicle to which the charging cable is connected.
